(19) United States
(12) Patent Application Publication
(10) Pub. No.: US 2015/0326846 A1
(43) Pub. Date: Nov. 12, 2015

(54) SYSTEMS AND METHODS FOR PROCESSING VIDEO FRAMES

(71) Applicant: DDD IP Ventures, Ltd., Road Town (VG)

(72) Inventors: Kevin John Stec, Los Angeles, CA (US); Peshala Vishvajith Pahalawatta, Glendale, CA (US)

(21) Appl. No.: 14/709,185

(22) Filed: May 11, 2015

Related U.S. Application Data
(60) Provisional application No. 61/991,864, filed on May 12, 2014.

(51) Int. Cl. H04N 13/00; H04N 21/258; H04N 7/015

(52) U.S. Cl. CPC H04N 13/0029; H04N 13/0048; H04N 13/0059; H04N 13/0037; H04N 7/015; H04N 21/25825; H04N 2013/0077

(57) ABSTRACT

An apparatus for processing image or video information is provided. The apparatus comprises a memory circuit configured to store video content and enhancement information for the video content. The apparatus also comprises a processor coupled to the memory circuit. The processor is configured to generate a video frame of a frame size that is compliant with a frame format for video content having a first spatial resolution. The video frame comprises at least a first sub-frame and a second sub-frame. The first sub-frame comprises an image of video content having a second spatial resolution, the first spatial resolution being greater than the second spatial resolution. The second sub-frame comprises enhancement information for the video content of the first sub-frame.

### CROSS REFERENCE TO RELATED APPLICATIONS

This application claims priority under 35 U.S.C. §119(e) to U.S. Provisional Application No. 61/991,864, entitled “SYSTEMS AND METHODS FOR FRAME COMPATIBLE HIGH DYNAMIC RANGE, WIDE COLOR GAMUT, AND HIGH FRAME RATE CONTENT DELIVERY,” filed May 12, 2014, the entirety of which is hereby incorporated by reference.

### TECHNICAL FIELD

This disclosure is generally related to image and video processing. More specifically, this disclosure is related to frame compatible high dynamic range (HDR), wide color gamut (WCG), high frame rate (HER), and stereoscopic three-dimensional (3D) content delivery.

### BACKGROUND

Certain technological improvements in image and video have provided video content with increased spatial resolution, dynamic range/color gamut, frame rate and also stereoscopic three-dimensional (3D) views. The consumer video industries have created standardized video formats and infrastructure for producing high spatial resolution video content and displays. These standardized video formats may not provide high dynamic range (HDR) and wide color gamut (WCG) video content, high frame rate (HER) video content, or 3D video content. There is a need to provide HDR/WCG, HER, or 3D video content using existing video formats and infrastructure.

### SUMMARY

An apparatus for processing image or video information is provided. The apparatus comprises a memory circuit configured to store video content and enhancement information for the video content. The apparatus also comprises a processor coupled to the memory circuit. The processor is configured to generate a video frame of a frame size that is compliant with a frame format for video content having a first spatial resolution. The video frame comprises at least a first sub-frame and a second sub-frame. The first sub-frame comprises an image of video content having a second spatial resolution, the first spatial resolution being greater than the second spatial resolution. The second sub-frame comprises enhancement information for the video content of the first sub-frame.

A method for processing image or video information is also provided. The method comprises storing video content and enhancement information for the video content. The method also comprises generating a video frame of a frame size that is compliant with a frame format for video content having a first spatial resolution. The video frame comprises at least a first sub-frame and a second sub-frame. The first sub-frame comprises an image of video content having a second spatial resolution, the first spatial resolution being greater than the second spatial resolution. The second sub-frame comprises enhancement information for the video content of the first sub-frame.

An apparatus for processing image or video information is also provided. The apparatus comprises means for storing store video content and enhancement information for the video content. The apparatus also comprises means for generating a video frame of a frame size that is compliant with a frame format for video content having a first spatial resolution. The video frame comprises at least a first sub-frame and a second sub-frame. The first sub-frame comprises an image of video content having a second spatial resolution, the first spatial resolution being greater than the second spatial resolution. The second sub-frame comprises enhancement information for the video content of the first sub-frame.

An apparatus for rendering image or video information is also provided. The apparatus comprises a memory circuit configured to store video content and enhancement information for the video content. The apparatus also comprises a processor coupled to the memory circuit. The processor is configured to receive a video frame of a frame size that is compliant with a frame format for video content having a first spatial resolution. The video frame comprises at least a first sub-frame and a second sub-frame. The first sub-frame comprises an image of video content having a second spatial resolution, the first spatial resolution bring greater than the second spatial resolution. The second sub-frame comprises enhancement information for the image of the first sub-frame. The processor is further configured to generate an enhanced video frame based on the image of video content of the first sub-frame and the enhancement information, the enhanced video frame having the second spatial resolution.

### BRIEF DESCRIPTION OF THE DRAWINGS

The various features illustrated in the drawings may not be drawn to scale. Accordingly, the dimensions of the various features may be arbitrarily expanded or reduced for clarity. Furthermore, dotted or dashed lines and objects may indicate optional features or be used to show organization of components. In addition, some of the drawings may not depict all of the components of a given system, method or device. Finally, like reference numerals may be used to denote like features throughout the specification and figures.

FIG. 1 shows a high-level overview of an encoding and display system.

FIG. 2 is a functional block diagram of components utilized in the frame packing and encoding system of FIG. 1.

FIG. 3 is a functional block diagram of interactions between the processor, the filter, and the video encoder of FIG. 2.

FIG. 4 is a functional block diagram of components utilized in the decoding and rendering system of FIG. 1.

FIG. 5 is a functional block diagram of interactions between the video decoder, the video renderer, and the display device of FIG. 4.

FIG. 6 is a diagram of an exemplary packed video frame providing additional temporal resolution and color enhancement information.

FIG. 7 is a diagram of another exemplary packed video frame providing stereoscopic 3D views and color enhancement information.

FIG. 8 is a diagram of another exemplary packed video frame providing color enhancement information and salience information.

FIG. 9 is a diagram of another exemplary packed video frame providing color enhancement information, salience information, and depth/object segmentation information.

FIG. 10 is a diagram of another exemplary packed video frame providing color enhancement information and metadata maps.

FIG. 11 is a diagram of another exemplary packed video frame providing scalable color enhancement information.

FIG. 12 is a flow chart of a method for packing video frames using the frame packing and encoding system.

FIG. 13 is a flow chart of a method for rendering enhanced video content using the decoding and rendering system.

### DETAILED DESCRIPTION

Various aspects of the novel systems, apparatuses, and methods are described more fully hereinafter with reference to the accompanying drawings. The disclosure may, however, be embodied in many different forms and should not be construed as limited to any specific structure or function presented throughout this disclosure. Rather, these aspects are provided so that this disclosure will be thorough and complete. The scope of the disclosure is intended to cover any aspect of the novel systems, apparatuses, and methods disclosed herein, whether implemented independently or combined. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure. It should be understood that any aspect disclosed herein may be embodied by one or more elements of a claim.

Furthermore, although particular aspects are described herein, many variations and permutations of these aspects fall within the scope of the disclosure. Although some benefits and advantages of the exemplary embodiments are mentioned, the scope of the disclosure is not intended to be limited to particular benefits, uses, or objectives. Rather, aspects of the disclosure are intended to be broadly applicable to different system configurations, video standards, coding standards, and color spaces, some of which are illustrated by way of example in the figures and in the following description of the exemplary embodiments. The detailed description and drawings are merely illustrative of the disclosure rather than limiting, the scope of the disclosure being defined by the appended claims and equivalents thereof.

This disclosure provides systems and methods for frame compatible high dynamic range (HDR), wide color gamut (WCG), high frame rate (HFR), and stereoscopic three-dimensional (3D) video content delivery. The systems and methods disclosed herein may provide packed video frames comprising multiple sub-frames, where each sub-frame comprises an image of video content or enhancement information.

In image and video processing, dynamic range generally refers to a range of luminance that may be reproduced by a display device, where luminance generally refers to a measure of perceived brightness/darkness (i.e., contrast) of light. Color gamut generally refers to a subset of visible colors that may be reproduced by a display device, where the reproducible colors are mapped as a coordinate on a color space (e.g., International Commission on Illumination (CIE) 1931 RGB or CIE 1931 XYZ). High frame rate video content generally refers to content that has a higher number of frames per second (fps) compared to traditional video formats for a particular application (e.g., 48 fps compared to the traditional 24 fps used for Digital Cinema). And, stereoscopic 3D video content generally refers to video content having two perspectives or views that provide a perception of depth (e.g., a stereoscopic left and right view).

The term “baseline” video content generally refers to video content produced according to a standardized video format using existing infrastructure. The standard determines the spatial resolution, dynamic range, color gamut, and frame rate for the baseline video content. In the video industry, the International Telecommunication Union Recommendation (ITU-R) BT.709 (hereinafter “Rec. 709”) format is a standard for high-definition television (HDTV). The Rec. 709 standard specifies spatial resolutions, frame rates, and color space. For example, the Rec. 709 color space covers about 35.9% of CIE 1931 color space. In some exemplary embodiments, Rec. 709 video content may serve as the baseline video content. The baseline video content may also be formatted according to other video standards. For example, another video standard is the ITU-R BT. 2020 (hereinafter “Rec. 2020”) format for ultra-high definition television (UHDTV). The Rec. 2020 standard specifies spatial resolutions, frame rates, and color space. For example, the Rec. 2020 standard specifies spatial resolutions of 3840×2160 (“4K”) and 7680×4320 (“8K”). The Rec. 2020 colorspace covers about 75.8% of the CIE 1931 colorspace.

The term “enhanced” video content generally refers to video content having a higher dynamic range, a wider color gamut, a higher frame rate, an addition dimensional view (i.e. 3D), or additional information compared to the baseline video content. For example, in embodiments where the baseline video content comprises Rec. 709 video content, the enhanced video content may have a higher frame, a higher dynamic range, or a wider color gamut compared to the Rec. 709 standard. Such enhanced video content may provide improved visual quality compared to baseline video content having a higher spatial resolution than the enhanced video content. Accordingly, there is a need to provide enhanced video content (e.g., HDR/WCG, HFR, or 3D video content) using the existing high spatial resolution video content standards (e.g., Rec. 2020) and infrastructure.

The systems and methods described herein allow for an existing frame format to provide enhanced video content, without modifying the existing coding standards or infrastructure. By contrast, certain other systems and methods may provide enhanced video content by using a 2-channel encoder or by modifying existing infrastructure, such as coding standards or decoders. For example, the Moving Picture Experts Group (MPEG) is developing a 12-bit mode of the High Efficiency Video Coding (HEVC) standard that may deliver HDR/WCG content but requires modification of decoder implementations since the current HEVC profile only covers 8 and 10-bit content.

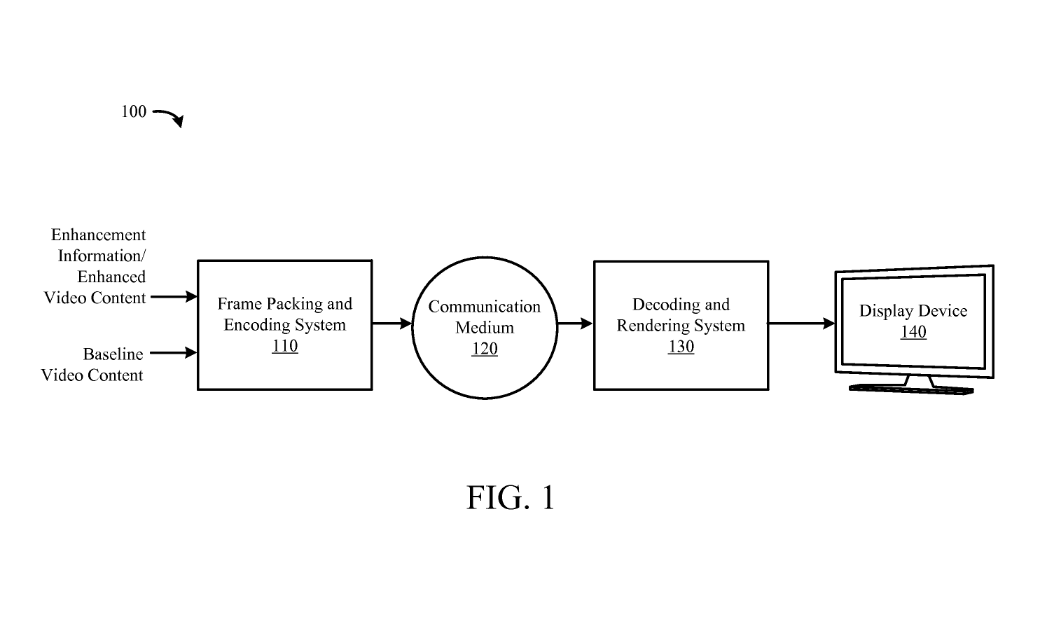

FIG. 1 shows a high-level overview of an encoding and displaying system 100. The encoding and displaying system 100 comprises a frame packing and encoding system 110. The frame packing and encoding system 110 is configured to receive a source of baseline video content (e.g., Rec. 709 video content) and a source of enhanced video content (e.g., HDR/WCG video content) and/or enhancement information. Some of the enhancement information may include dynamic range enhancement information, color gamut enhancement information, frame rate enhancement information, image salience information, image depth information, object segmentation information, and rendering information. The frame packing and encoding system 110 is configured to generate and encode packed video frames comprising the baseline video content and the enhancement information. Examples of packed video frames are described below in connection with FIGS. 6-11.

The encoding and displaying system 100 also comprises a decoding and rendering system 130. The frame packing and encoding system 110 may provide the encoded packed video frames to the decoding and rendering system 130 via a communication medium 120 (e.g., cable service, satellite service, internet protocol (IP), or wireless local area network (WLAN)). The decoding and rendering system 130 is configured to decode the packed video frames. The decoding and rendering system 130 is further configured to identify the baseline video content and the enhancement information in the packed video frame. The decoding and rendering system 130 may be coupled to a display device 140. The decoding and rendering system 130 may receive display property information and viewing environment information from the display device 140. The decoding and rendering system 130 is configured to render the enhanced video content based on the baseline video content, the enhancement information, the display property information, and the viewing environment information as further described below.

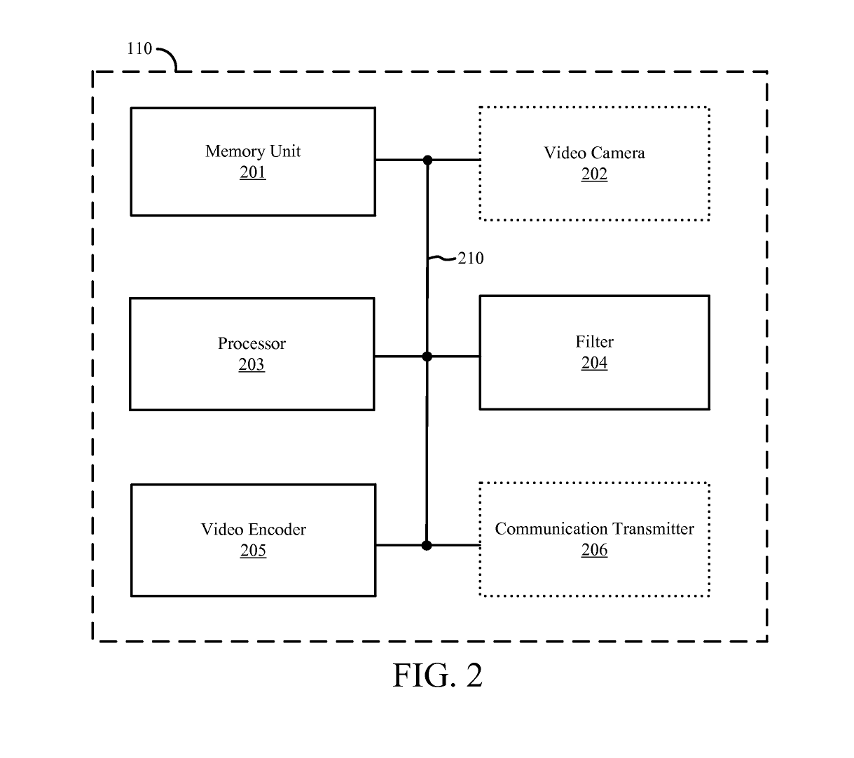

FIG. 2 is a functional block diagram of components utilized in the frame packing and encoding system 110 of FIG. 1. The components described below generally provide the frame packing and encoding system 110 with the capability to generate and encode the packed video frames.

The frame packing and encoding system 110 comprises a memory unit 201. The memory unit 201 is configured to store the packed video frames, the baseline video content, the enhanced video content, the enhancement information, and any other information or data described herein. The memory unit 201 may comprise both read-only memory (ROM) and random access memory (RAM). A portion of the memory unit 201 may also include non-volatile random access memory (NVRAM).

The frame packing and encoding system 110 may optionally comprise a video camera 202. The video camera 202 may include a plurality of video cameras for capturing and recording video content. The video camera 202 is configured to capture the baseline video content and/or the enhanced video content.

The frame packing and encoding system 110 comprises a processor 203. The processor 203 may be implemented with any combination of processing circuits, general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processor 203 is configured to execute instruction codes (e.g., in source code format, binary code format, executable code format, or any other suitable format of code). The processor 203 is configured to receive the instructions from the memory unit 201. The processor 201 may execute the instructions to perform, for example, scaling of images of video content, conversion of the color space of video content, generation of luminance and chrominance information, transformation of the bit-depth of the video content, and packing of the video frames, as described below.

The frame packing and encoding system 110 may also comprise a filter 204. The filter 204 may comprise a low-pass filter. The filter 204 is configured to filter the video content to avoid or minimize artifacts, such as contouring and banding, in filtered images of the video content.

The frame packing and encoding system 110 may also comprise a video encoder 205. The video encoder 205 is configured according to at least one coding standard (e.g., AVC/H.264, HEVC/H.265, VP9, etc.). The video encoder 205 may comprise a plurality of encoding circuits. The video encoder 205 is configured to encode the packed video frames.

The frame packing and encoding system 110 may optionally comprise a communication transmitter 206. The communication transmitter 206 is configured to allow for transmission of data from the frame packing and encoding system 110 to the decoding and rendering system 130 via the communication medium 120. The communication transmitter 206 is configured to transmit a bitstream comprising the encoded packed video frame. The transmitter 206 is also be configured to transmit a metadata signal to the decoding and rendering system 130. The metadata signal provides information regarding the encoding and rendering process as further described below.

The frame packing and encoding system 110 comprises a bus system 210. The bus system 210 is configured to couple each component of the frame packing and encoding system 110 to each other component in order to provide information transfer. Although a number of separate components are shown in FIG. 2, one or more of the components may be combined or commonly implemented. Further, each of the components shown in FIG. 2 may be implemented using a plurality of separate elements.

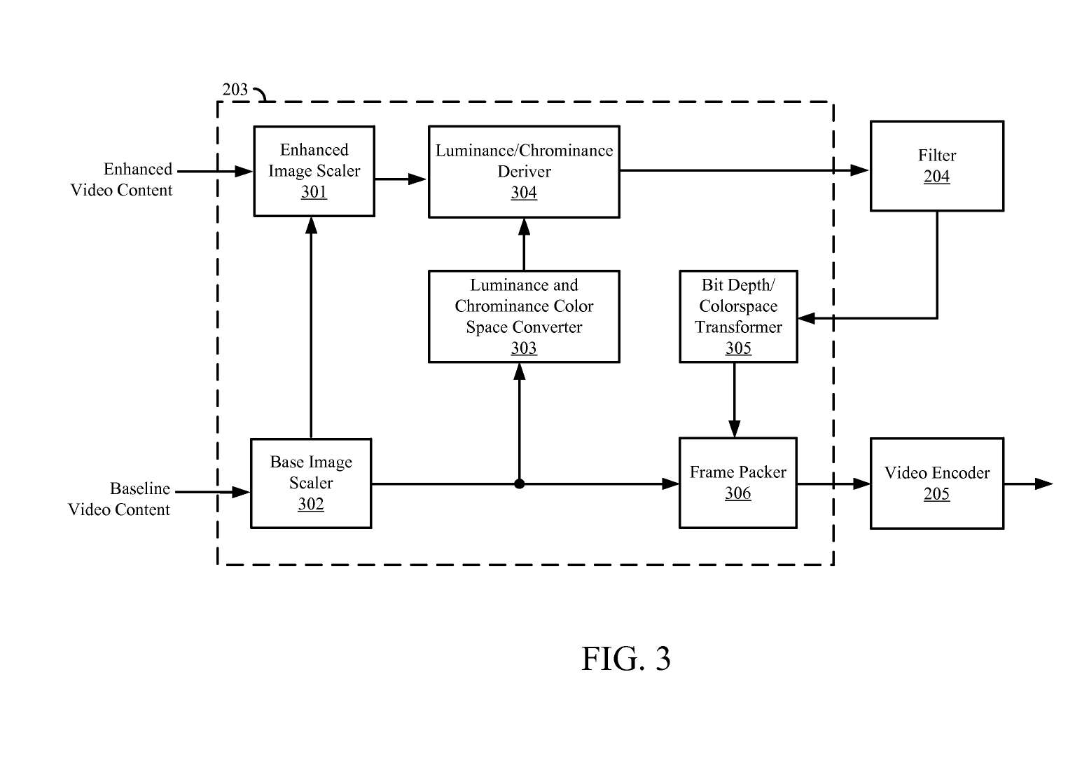

FIG. 3 is a functional block diagram of interactions between the processor 203, the filter 204, and the video encoder 205 of FIG. 2. The processor 203 receives the baseline video content (e.g., Rec. 709 video content), the enhanced video content (e.g., HDR/WCG video content), and/or the enhancement information from the memory unit 201 or the video camera 202. The processor 203 is also configured to generate the enhancement information based on a comparison of the enhanced video content and the baseline video content.

The enhanced video content may be pixel aligned with the baseline video content such that objects in corresponding images of both the enhanced video content and the baseline video content have the same pixel positions. Pixel aligned baseline video content and enhanced video content may be readily available for post-produced content, for example, feature films and episodic TV programs. In video, post-production generally refers to a process whereby an artist creatively modifies video content in order to present a desired visual effect. The post-production process (not shown) may include, for example, video editing, image editing, color correction, and subsampling of the video content. In some embodiments, the processor 203 receives the baseline video content and the enhanced video content from such a post-production process. The processor 203 may be further configured to generate packed video frames that maintain the artistic intent created in the post-production process.

Referring to FIG. 3, the processor 203 is configured to generate the packed video frames, each packed video frame comprising a plurality of sub-frames. In this embodiment, the packed video frames comprise UHDTV1 format video frames having a spatial resolution of 3840×2160. Each packed video frame comprises four sub-frames, each sub-frame having a spatial resolution of 1920×1080 (1080P). However, the baseline video content and/or the enhanced video content may comprise images having a spatial resolution that differs from the spatial resolution of the 1080P sub-frames. In order to fit the baseline video content and the enhancement information into the 1080P sub-frames, the processor 203 comprises image scalers. In this embodiment, the processor 203 comprises a base image scaler 302 configured to receive the baseline video content as input. The base image scaler 302 is configured to proportionally scale the spatial resolution of the baseline video content up or down to the spatial resolution of the sub-frames (e.g., 3840×2160, 1920×1080, or 1280×720). For example, the base image scaler 302 may increase the spatial resolution of the baseline video content or it may decrease the spatial resolution of the baseline video content. The processor 203 also comprises an enhanced image scaler 301. The enhanced image scaler 301 is configured to proportionally scale the spatial resolution of the enhanced video content up or down to the spatial resolution of the sub-frames (e.g., 3840×2160, 1920×1080, or 1280×720). For example, the enhanced image scaler 302 may increase the spatial resolution of the enhanced video content or it may decrease the spatial resolution of the enhanced video content.

In some embodiments, the baseline video content and the enhanced video content comprise UHDTV1 images and the sub-frames have 1080P spatial resolution. In such embodiments, the base image scaler 302 and the enhanced image scaler 301 are configured to scale the UHDTV1 spatial resolution images down to 1080P spatial resolution images. As such, the base image scaler 302 and the enhanced image scaler 301 may provide scaled images having a spatial resolution equal to the 1080P sub-frames. In other embodiments, the baseline video content and the enhanced video content comprise 1080P images and the sub-frames have 1080P spatial resolution. In such embodiments, the base image scaler 302 and the enhanced image scaler 301 may not perform scaling.

The processor 203 may also comprise a luminance and chrominance color space converter (“color space converter”) 303 coupled to the base image scaler 302. The color space converter 303 is configured to receive the scaled base images of the baseline video content from the base image scaler 302. In some embodiments, the baseline video content is formatted according to a color space that is different from a color space of the enhanced video content. In these embodiments, the color space converter 303 is configured to convert the images of the scaled baseline video content to the color space of the enhanced video content. For example, the baseline video content may be in the YUV color space and the enhanced video content may be in the XYZ color space. In this example, the color space converter 303 is configured to perform a colorspace transformation to convert the baseline video content to the XYZ color space. As such, the color space converter 303 allows the processor 203 to perform direct comparisons between the baseline video content and the enhanced video content. In other embodiments, the baseline video content and the enhanced video content may be in different color spaces. In some embodiments, the baseline video content and the enhanced video content may be in the same color space.

The processor 203 may also comprise a luminance/chrominance deriver 304 coupled to the enhanced image scaler 301 and the luminance and chrominance color space converter 303. The luminance/chrominance deriver 304 is configured to receive the scaled enhanced video content from the enhanced image scaler 301 and the scaled and converted baseline video content from the color space converter 303. The luminance/chrominance deriver 304 is configured to apply a division operator on luminance values of the converted baseline video content and luminance values of the enhanced video content in order to generate a luminance ratio image. The luminance/chrominance deriver 304 may also be configured to apply a difference operator on chrominance values of the converted baseline video content and chrominance values of the enhanced video content to generate a chrominance difference vector. The luminance ratio image and the chrominance difference vector may provide an indication for scaling the baseline video content (e.g., a low dynamic range base image Rec. 709 image) to restore the enhanced video content (e.g., HDR/WCG video content). The luminance ratio image and the chrominance difference vector may be referred to as “color enhancement information.”

For further information on deriving color enhancement information, reference is made to U.S. Provisional Application No. 61/942,013, entitled “SYSTEMS AND METHODS FOR BACKWARD COMPATIBLE HIGH DYNAMIC RANGE/WIDE COLOR GAMUT VIDEO CODING AND RENDERING,” and filed Mar. 4, 2014, which is hereby incorporated by reference in its entirety.

The filter 204 is coupled to the luminance/chrominance deriver 304. The filter 204 may comprise a low-pass filter circuit. The filter 204 is configured to receive the luminance ratio image and the chrominance difference vector from the luminance/chrominance deriver 304. The filter 204 is configured to filter both the luminance ratio image and chrominance difference vector in order to avoid or minimize artifacts, such as contouring and banding, in the filtered images.

The processor 203 may also comprise a bit depth/colorspace transformer (“transformer”) 305 coupled to the filter 204. The transformer 305 is configured to receive the filtered luminance ratio image and the filtered chrominance difference vector from the filter 204. The transformer 305 is configured to transform the luminance ratio image and chrominance difference vector using separate linear or non-linear functions so that the luminance ratio image and chrominance difference vector fit within an available bit-depth and a color-space representation of the video encoder 205. In other embodiments of the processor 203, the transformer 305 functional block and the filter 204 functional block may swap positions such that the bit-depth and color-space transformation is performed before filtering.

The processor 203 may also comprise a frame packer 306 coupled to the base image scaler 302 and the transformer 305. The frame packer 306 is configured to generate the packed video frame described herein. The packed video frame may be formatted according to the coding standard used by the video encoder 205. In this embodiment, the frame packer 306 is configured to receive the scaled baseline video content from the base image scaler 302 and the transformed luminance ratio image and chrominance difference vector from the transformer 305. The frame packer 306 is configured to include the scaled baseline video content and the transformed luminance ratio image and chrominance difference vector into sub-frames of a packed video frame.

As described below in connection with FIGS. 6-11, the frame packer 306 may generate a packed video frame including one or more images and different types of enhancement information. Each of the sub-frames may comprise an image of video content or enhancement information. In this embodiment, the frame packer 306 generates a packed video frame comprising a first sub-frame including a scaled image of baseline video content and a second sub-frame including the ratio image/difference vector. The frame packer 306 may also be configured to generate an additional metadata signal (e.g., an H.264 supplemental enhancement information (“SEI”) message). The metadata signal may specify a particular frame packing arrangement for the packed video frames as well as additional information related to rendering the video content on displays of different capabilities. For example, the metadata signal may indicate the color space, the sub-frame format, the color and luminance range, and rendering data. The metadata signal may be provided to the decoding and rendering system 130.

The frame packer 306 provides several advantages. The standardized frame format used for the packed video frame may not be intended to provide enhanced video content. However, the frame packer 306 provides packed video frames that may be used to derive the enhanced video content. In addition, the video encoder 205 is configured to encode the packed video frames having the standardized frame format but the video encoder 205 may not be configured to encode the enhanced video content itself. As such, packed video frames provided by the frame packer 306 provide the enhanced video content without requiring new coding standards, changes to existing coding standards, or new infrastructure. For example, enhanced video content may cover a higher percentage of the CIE 1931 color space compared to the percentage of the CIE 1931 color space covered by the standardized video frame format used for the packed video frame. The enhanced video content may also have a higher frame rate than the frame rate supported by the standardized video frame format used for the packed video frame.

As described above, the video encoder 205 is configured to encode the packed video frames and encode the metadata signal from the frame packer 306. The video encoder 205 may comprise an encoder circuit configured according to an appropriate level and profile to accommodate UHDTV signals using a coding standard such as the Advanced Video Coding (AVC)/H.264 coding standard, the High Efficiency Video Coding (HEVC)/H.265 coding standard, the VP9 coding standard, or another coding standard. The video encoder 205 is configured to transform bits of the packed video frames and the metadata signal according to a coding standard to generate the encoded bitstream. As described in U.S. Provisional Application No. 61/942,013, a low dynamic range image (e.g., Rec. 709) and a corresponding HDR/WCG enhancement image may be independently coded. Accordingly, the video encoder 205 may be configured to encode each sub-frame of the packed video frame separately to avoid contamination from one sub-frame to the other. For example, the video encoder 205 may restrict the use of prediction to blocks of pixels that are within a single sub-frame. Furthermore, the video encoder 205 may also be configured to modify encoding parameters such as quantization parameters for each sub-frame separately in order to optimize compression efficiency. For example, the video encoder 205 may use finer quantization parameters for blocks of pixels within sub-frames comprising enhancement information compared to the quantization parameters used for blocks of pixels within sub-frames comprising an image of baseline video content. The communication transmitter 206 (shown in FIG. 2) is configured to transmit the encoded bitstream to the decoding and rendering system 130.

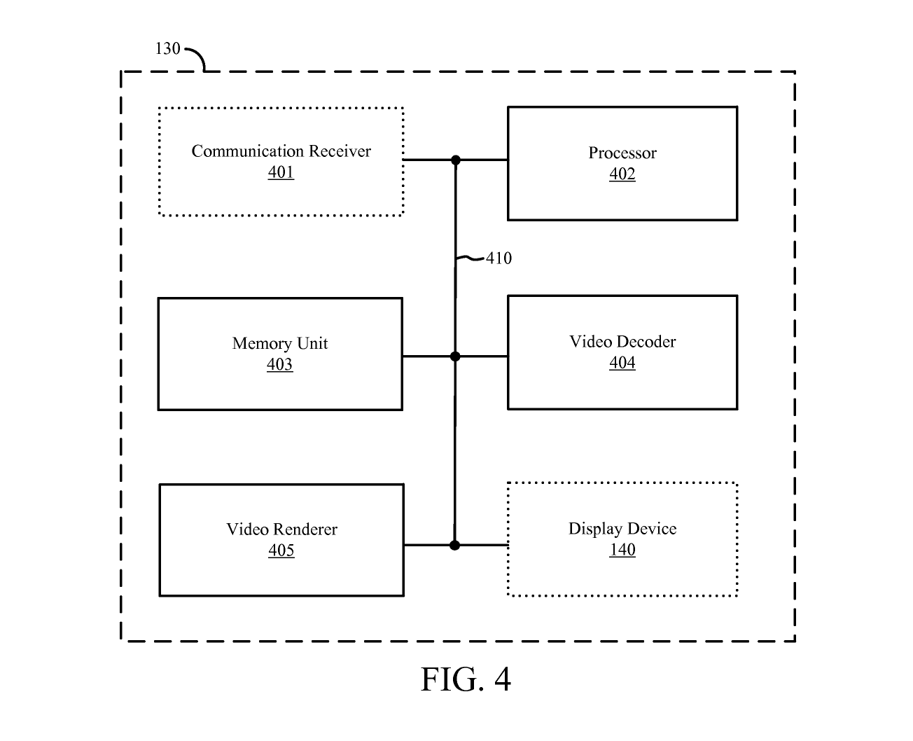

FIG. 4 is a functional block diagram of components utilized in the decoding and rendering system 130 of FIG. 1. The components described below generally provide the decoding and rendering system 130 with the capability to decode and render the packed video frames.

The decoding and rendering system 130 optionally comprises a communication receiver 401. The communication receiver 401 is configured to receive the encoded bitstream from the communication transmitter 206 via the communication medium 120. As mentioned above, the encoded bitstream may comprise the packed video frames and the metadata signal.

The decoding and rendering system 130 may also comprise a memory unit 403. The memory unit 403 is configured to store the packed video frames, the baseline video content, the enhanced video content, the enhancement information, the metadata, and any other information or data described herein. The memory unit 403 may comprise both read-only memory (ROM) and random access memory (RAM). A portion of the memory unit 403 may also include non-volatile random access memory (NVRAM).

The decoding and rendering system 140 may also comprise a processor 402. The processor 402 may be implemented with any combination of processing circuits, general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information. The processor 402 is configured to execute instruction codes (e.g., in source code format, binary code format, executable code format, or any other suitable format of code). The processor 402 may receive the instructions from the memory unit 403. The instructions, when executed by the processor 402, may control the decoding and rendering as described herein.

The decoding and rendering system 130 may also comprise a video decoder 404. The video decoder 404 is configured according to at least one coding standard (e.g., AVC/H.264, HEVC/H.265, VP9, etc.). The video decoder 404 may be configured according to the same coding standard as the video encoder 205 of the frame packing and encoding system 110. The video decoder 404 may comprise a plurality of decoding circuits. The video decoder 404 is configured to decode the packed video frames and the metadata from the encoded bitstream.

The decoding and rendering system 130 may also comprise a video renderer 405. The video renderer 405 is configured to render video content based on the baseline video content and the enhancement information. The video renderer 405 may also render the enhanced video content based on the metadata signal. The decoding and rendering system 130 may optionally comprise the display device 140. The video renderer 405 may receive display properties from the display device 140. The video renderer 405 is configured to render the enhanced video content based on the display properties such that it can be displayed by the display device 140.

The decoding and rendering system 130 may also comprise a bus system 410. The bus system 410 is configured to couple each component of the decoding and rendering system 130 to each other component in order to provide information transfer. Although a number of separate components are shown in FIG. 4, one or more of the components may be combined or commonly implemented. Further, each of the components shown in FIG. 4 may be implemented using a plurality of separate elements.

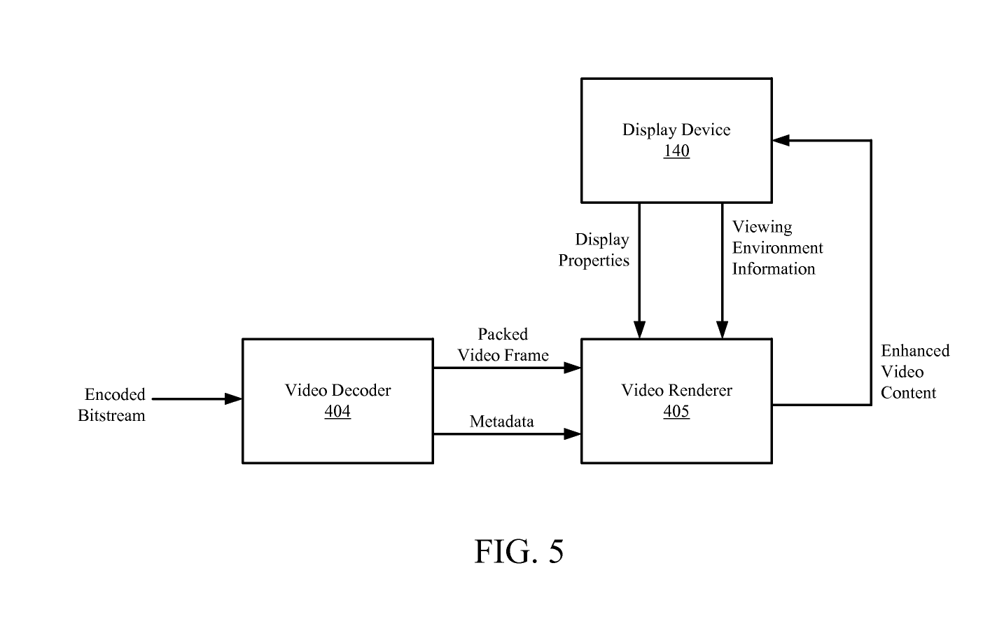

FIG. 5 is a functional block diagram of interactions between the video decoder 404, the video renderer 405, and the display device 140 of FIG. 4. The video decoder 404 may receive the encoded bitstream including the packed video frames and the metadata. The video decoder 404 is configured to transform bits of the encoded bitstream to decode the packed video frames and the metadata.

As described in connection with FIG. 4, the video renderer 405 is configured to receive the packed video frames and the metadata signal from the video decoder 404. In some embodiments, the packed video frames may comprise UHDTV1 format video frames, each video frame comprising four 1080P spatial resolution sub-frames. The video renderer 405 is configured to divide the packed UHDTV1 video frame into the four 1080P sub-frames. In some embodiments, the metadata signal provides an indication of the frame packing format that the frame packer 306 used to generate the packed video frame. In such embodiments, the video renderer 405 may divide the packed video frame based on the metadata signal to identify images and the enhancement information. In other embodiments, the video renderer 405 and the frame packer 306 may be preprogrammed to use the same frame packing format for the packed video frames.

As described below in connection with FIGS. 6-11, the video renderer 405 is configured to derive and render the enhanced video content based on the baseline video content, the enhancement information, and the metadata. For example, HDR/WCG video content may be derived from base video content using color enhancement information as described in U.S. Provisional Application No. 61/942,013. In another example, the video renderer 405 is configured to temporally arrange sub-frame images of the packed frames content in presentation order to provide HFR video content. In another example, the video renderer 405 is configured to format left view images and right view sub-frame images into a 3D format (e.g., the HDMI 1.4a 3D format) to generate 3D video content. As such, the video renderer 405 may provide enhanced video content using the packed video frame.

In some embodiments, the video renderer 405 is coupled to the display device 140. The video renderer 405 is configured to receive display properties and viewing environment information from the display device 140. For example, the display device 140 may provide display properties indicating that the display device 140 has a maximum brightness level of 1000 nits. The display device 140 may also provide viewing environment information indicating that the ambient light level near the display is higher (e.g., a sunny day) and that the color temperature of the room is warm. The video renderer 405 is further configured to render the enhanced video content based on the display properties and the viewing environment information. In one example, the video renderer 405 receives display properties indicating that the display device 140 is Rec. 709 compatible and renders Rec. 709 video content. In another example, the video renderer 405 receives display properties indicating that the display device 140 is capable of displaying HFR and HDR/WCG video content and the video renderer 405 renders HFR, HDR/WCG video content. In another example, the video renderer 405 receives display properties indicating that the display device 140 is capable of displaying a portion of the HDR/WCG colorspace and the video renderer 405 scales the colorspace of the HDR/WCG video content to fit the display properties. In another example, the video renderer 405 receives viewing environment information indicating the lighting conditions around the display device 140 and the video renderer 405 adjusts the brightness and contrast levels of the rendered video content. As such, the video renderer 405 may provide video content that is compatible with a variety of display devices 140 having different HFR/HDR/WCG capabilities.

FIGS. 6-11 show examples of packed video frames that generated by the frame packer 306 and rendered by the video renderer 405. While FIGS. 6-11 show certain images and certain types of enhancement information in certain sub-frames, the ordering and position of the sub-frames within the video frames may be changed and the content of the sub-frames may be changed. Furthermore, the frame packer 306 is be configured to generate a packed video frame including any number and combination of the sub-frames discussed herein. As such, the packed video frames are not limited to four sub-frames, but may include any number of sub-frames, (e.g., 2, 3, 4, 6, 8, 12, or 16 sub-frames). In addition, the sub-frames may also include other types of enhancement information for improving the visual quality of the baseline video content.

FIG. 6 shows a diagram of a packed video frame 600 providing additional temporal resolution and color enhancement information. The outside box shown in FIG. 6 represents the packed video frame 600. In this exemplary embodiment, the packed video frame 600 comprises a “4K” UHDTV1 format video frame having a spatial resolution of 3840×2160. The frame packer 306 is configured to generate the packed video frame 600.

The packed video frame 600 is logically partitioned into four regions, delineated by the dotted lines shown in FIG. 6, each region representing a sub-frame of the packed video frame 600 (e.g., upper-left, upper-right, lower-left, and lower-right sub-frames). In this embodiment, each sub-frame of the packed video frame 600 has a 1080P spatial resolution. In this embodiment, one or more of the sub-frames comprise images of video content. The upper-left sub-frame 601 comprises a frame n base image, where n indicates a position of a single video frame in a sequence of video frames in the baseline video content. In addition, the lower-left sub-frame 603 comprises a frame n+1 base image, where frame n+1 refers to the next video frame in time after frame n in the baseline video content. The video renderer 405 is configured to temporally arrange the frame n base image and the frame n+1 base image to provide additional temporal resolution (e.g., increased frame rate) compared to the baseline video content.

In this embodiment, one or more of the sub-frames comprise enhancement information. In this embodiment, the upper-right sub-frame 602 comprises frame n color enhancement information that may be used by the video renderer 405 to increase a dynamic range and color gamut of the frame n base image in order to generate an HDR/WCG image (e.g., a frame of color enhanced video content). In addition, the lower-right sub-frame 604 comprises frame n+1 color enhancement information that may be used by the video renderer 405 to increase a dynamic range and color gamut of the frame n+1 base image in order to provide an HDR/WCG image.

As such, the packed video frame 600 provides HDR/WCG video content at a higher frame rate compared to the baseline video content. For example, the packed video frame 600 may provide up to 60 fps, compared to 30 fps for the baseline video content, over a high-definition multimedia interface (HDMI). This configuration is also advantageous because the packed video frame 600 may be decoded using an existing UHDTV1 compatible video decoder, without modification of existing coding standards or infrastructure. Furthermore, the enhanced video content may provide improved visual quality compared to non-color enhanced, lower frame rate video content having a higher spatial resolution.

In other embodiments, the packed video frame 600 may comprise a UHDTV2 “8K” format video frame having a spatial resolution of 7680×4320. In such embodiments, the packed 8K video frame may comprise four 4K UHDTV1 spatial resolution sub-frames, or sixteen 1080P resolution sub-frames, or a different number of sub-frames having a different spatial resolution. The combined spatial resolution of the sub-frames may be less than or equal to the spatial resolution of the packed video frame 600. In other embodiments, at least one sub-frame may have a different spatial resolution compared to another sub-frame.

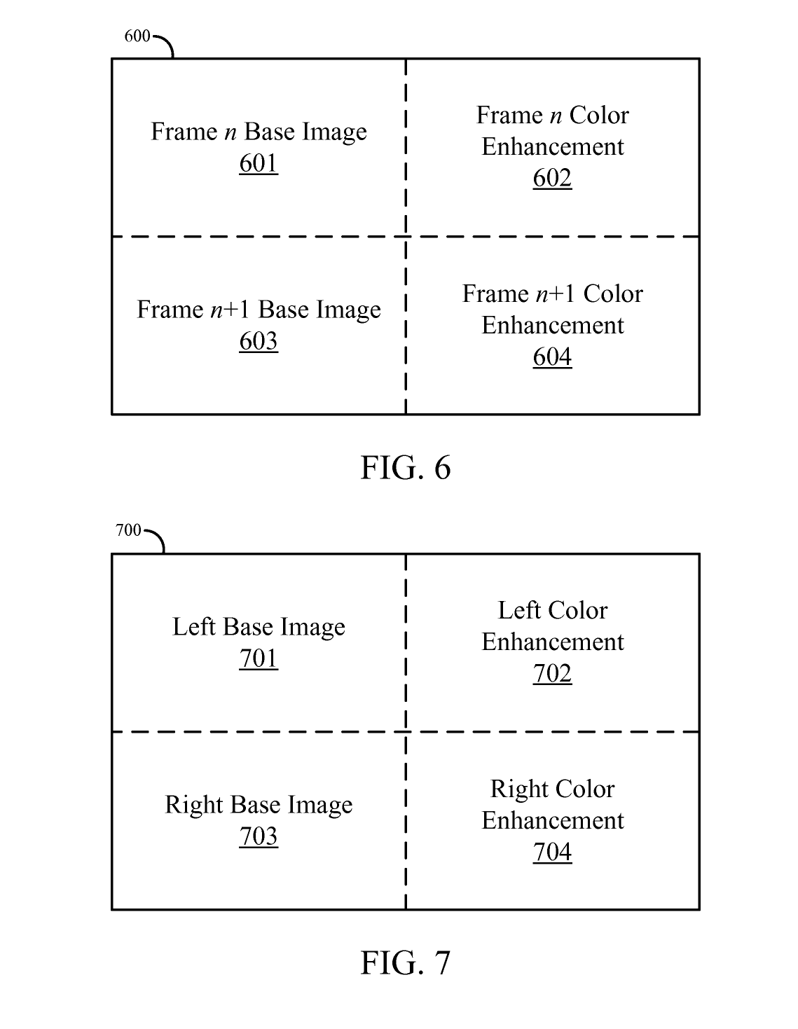

FIG. 7 shows a packed video frame 700 providing stereoscopic 3D views and color enhancement information. The packed video frame 700 of FIG. 7 may provide 3D/HDR/WCG video content as described herein. The packed video frame 700 may be configured similar to the packed video frame 600 except for the differences described below. In this embodiment, the packed video frame 700 comprises a UHDTV1 frame partitioned into four 1080P sub-frames. The upper-left sub-frame 701 comprises a left base image providing a left-view of stereoscopic 3D content. The upper-right sub-frame 702 comprises left color enhancement information that may be used by the video renderer 405 to increase a dynamic range and color gamut of the left base image in order to generate an HDR/WCG image, as described above. The lower-left sub-frame 703 comprises a right base image providing a right-view of the stereoscopic 3D content. And, the lower-right sub-frame 704 comprises right color enhancement information that may be used by the video renderer 405 to increase a dynamic range and color gamut of the right base image in order to generate an HDR/WCG image. As such, the frame packing format of FIG. 7 may provide HDR/WCG stereoscopic 3D video content at 1080P spatial resolution by packing two image views and color enhancement information into the UHDTV1 video frame.

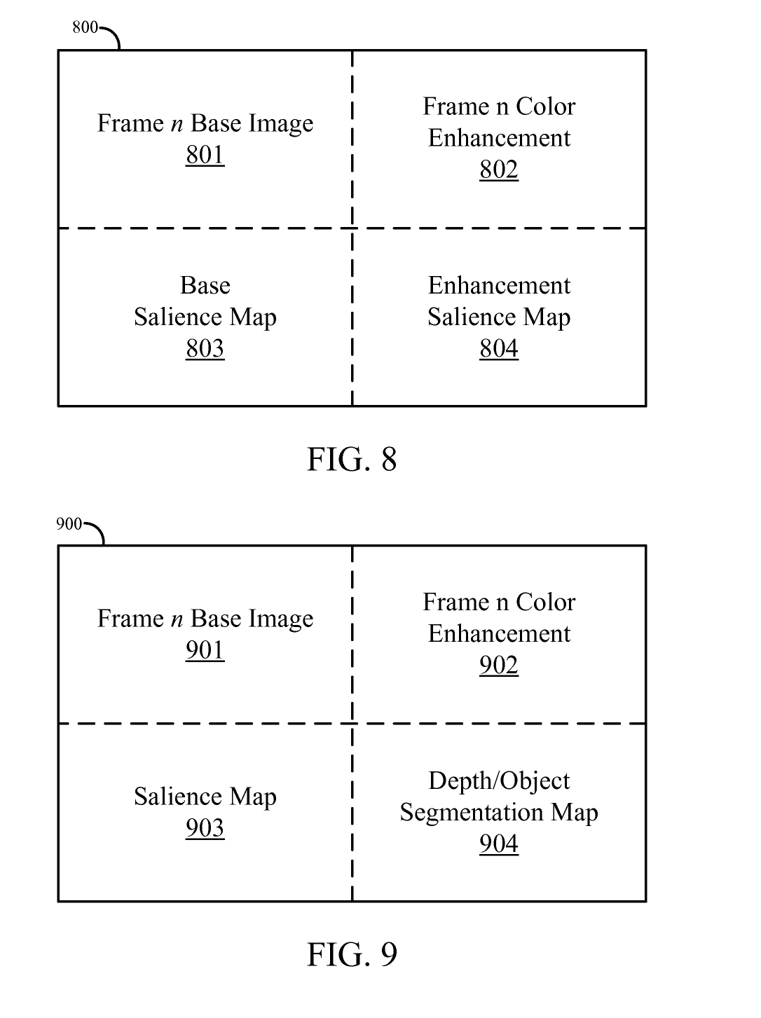

FIG. 8 shows a packed video frame 800 providing color enhancement information and salience information. In this embodiment, the packed video frame 800 of FIG. 8 may provide HDR/WCG video content that may be rendered by the video renderer 405 based on depth-based salience information. The packed video frame 800 may be configured similar to the packed video frame 600 except for the differences described below. In some embodiments, the frame packer 306 is configured to generate packed video frames providing such color enhancement information and salience information and the video renderer 405 is configured to render such packed video frames.

The video frame of FIG. 8 comprises four sub-frames. In this embodiment, the upper-left sub-frame 801 comprises a frame n base image of the baseline video content. The upper-right sub-frame 802 comprises frame n color enhancement information. The lower-left sub-frame 803 comprises a base depth-based salience map associated with the frame n base image. And, the lower-right sub-frame 804 comprises a depth-based salience map associated with the frame n enhancement information. For further information on depth-based salience maps, reference is made to U.S. patent application Ser. No. 14/260,098, entitled “SYSTEM AND METHOD FOR DEPTH BASED ADAPTIVE STREAMING OF VIDEO INFORMATION,” and filed Apr. 23, 2014, which is hereby incorporated by reference in its entirety.

The base depth-based salience map and the enhancement depth-based salience map may indicate regions of the base image and the enhancement image, respectively, that are more important or distinct (e.g., more salient). The video renderer 405 is further configured to provide rendered video content having greater fidelity in the more salient image regions based on the depth-based salience maps provided in the packed video frame 800. For example, the display device 140 may provide display properties indicating that the display device 140 is capable of displaying video content at a spatial resolution higher than a spatial resolution of the baseline video content. In this embodiment, the video renderer 405 is configured to upsample the decoded sub-frames to provide rendered video content at the spatial resolution indicated by the display properties. The video renderer 405 may also be configured to upsample less salient regions of the sub-frames using a less complex interpolation technique (e.g., nearest neighbor interpolation) and upsample more salient regions of the sub-frames using a more complex interpolation technique (e.g., bilateral filtering). Generally, more complex interpolation techniques may provide images that are more detailed and more accurate. As such, the video renderer 405 may render the sub-frames at a higher rate while using less power by limiting the processing complexity used for less salient regions of the image.

In another example, video renderer 405 may receive display properties from the display device 140 indicating that the display device 140 is capable of a frame rate that is different from a frame rate of the decoded baseline video content. In this example, the video renderer 405 is configured to convert the frame rate of the baseline video content to the frame rate of the display device 140. As described above, the video renderer 405 may receive packed video frames including depth-based salience maps which indicate more and less salient regions of the image. Accordingly, the video renderer 405 is further configured to interpolate more salient regions of the video content using a more complex motion compensated interpolation scheme (e.g., motion compensated interpolation) and to interpolate less salient regions of the image using a less complex method (e.g., frame averaging.

FIG. 9 shows a packed video frame 900 providing color enhancement information, salience information, and depth/object segmentation information. In this embodiment, the packed video frame 900 may provide HDR/WCG video content that may be rendered based on depth-based salience information and a depth/object segmentation map as described below. The packed video frame 900 may be configured similar to the packed video frame 600 except for the differences described below. The frame packer 306 is configured to generate packed video frames 900 providing enhancement information, salience information, and depth/object segmentation information and the video renderer 405 is configured to render packed video frames 900.

The packed video frame 900 comprises four sub-frames. In this embodiment, the upper-left sub-frame 901 comprises a frame n base image of the baseline video content. The upper-right sub-frame 902 comprises frame n color enhancement information. The lower-left sub-frame 903 comprises a base depth-based salience map associated with the frame n base image. And, the lower-right sub-frame 904 comprises a depth map or an object segmentation map that may identify regions of the image that belong to separate objects in the frame n base image. The video renderer 405 is configured to render each object of the frame n base image separately during image enhancement operations. As such, the video renderer 405 may adjust the complexity of the rendering process depending on the salience and location of the object to provide higher image quality. The video renderer 405 may also be configured to track the motion of objects in the video content over time. The video renderer 405 is configured to perform selective blurring, selective sharpening, and local contrast adjustments to regions of the image based on the motion of the objects in the images of the video content.

FIG. 10 shows a packed video frame 1000 providing color enhancement information and metadata maps. In this embodiment, the packed video frame 100 may provide HDR/WCG video content that may be rendered based on the rendering metadata maps as described below. The packed video frame 1000 may be configured similar to the packed video frame 600 except for the differences described below. The frame packer 306 is configured to generate packed video frames 1000 providing enhancement information and metadata maps and the video renderer 405 is configured to render such packed video frames 1000 as further described below.

The packed video frame 1000 comprises four sub-frames. In this embodiment, the upper-left sub-frame 1001 comprises a frame n base image of the baseline video content. The upper-right sub-frame 1002 comprises frame n color enhancement information. The lower-left sub-frame 1003 comprises a rendering metadata map 0 image. And, the lower-right sub-frame 1004 comprises a rendering metadata map 1 image. Each metadata map may provide per-pixel rendering parameters. In some embodiments, the rendering metadata maps may indicate parameters and functions to be used by the video renderer 405 for rendering the base images for display devices 140 of different capabilities. For example, as further described in U.S. patent application Ser. No. 14/260,098, the rendering metadata maps may indicate scaling/clipping functions that may be used by the video renderer 405 in rendering the base images. As described above, the frame packer 306 generates the metadata signal. The metadata may specify a particular frame packing arrangement as well as additional information related to rendering the video content on display devices 140 of different capabilities. In some embodiments, the rendering metadata maps may specify a rendering function based on a pre-defined lookup table of functions.

In some embodiments, a bit-depth of the lookup table may be smaller than a bit-depth used for encoding the video frames (e.g., 8, 10 or 12-bit) to avoid potential quantization errors created by encoding the rendering metadata map images. In some embodiments, chrominance values of the rendering metadata maps may indicate a function to be applied by the display renderer to color difference vectors of the frame n enhancement image for rendering to displays of a different color gamut.

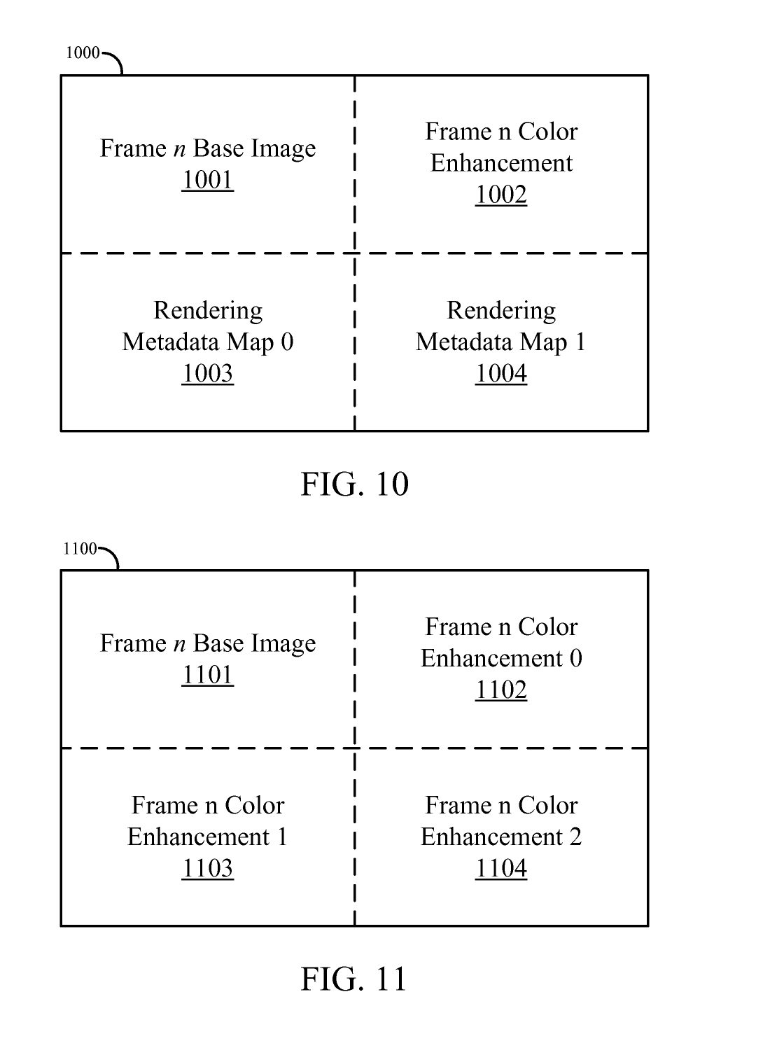

FIG. 11 shows a packed video frame 1100 providing scalable color enhancement information. In this embodiment, the packed video frame 1100 may provide different levels of HDR/WCG video content using the scalable color enhancement information. The packed video frame 1100 may be configured similar to the packed video frame 600 except for the differences described below. The frame packer 306 is configured to generate packed video frames 1100 providing scalable enhancement information and the video renderer 405 is configured to render such packed video frames 1100.

The video frame of FIG. 11 comprises four sub-frames. In this embodiment, the upper-left sub-frame 1101 comprises a frame n base image of the baseline video content. The upper-right sub-frame 1102 comprises frame n color enhancement 0 information. The lower-left sub-frame 1103 comprises frame n color enhancement 1 information. And, the lower-right sub-frame 1104 comprises frame n color enhancement 2 information. The color enhancement information sub-frames may include luminance ratio and chrominance difference information that map a low dynamic range base image up to higher levels of dynamic range and color gamut. The video renderer 405is further configured to select one of the three color enhancement information sub-frames to apply to the frame n base image based on the display properties received from the display device 140. The video renderer 405is further configured to select the color enhancement information sub-frame that is the closest to, but within, the capabilities of the coupled display device 140. As such, the video renderer 405 may scale the base image to a compatible dynamic range and color gamut without additional rendering.

In other embodiments, frame n base image may comprise an HDR/WCG base image and the other sub-frames may comprise dynamic range and color gamut reduction information that may comprise luminance ratio and chrominance difference information that map the HDR/WCG image down to a lower dynamic range and a narrower color gamut.

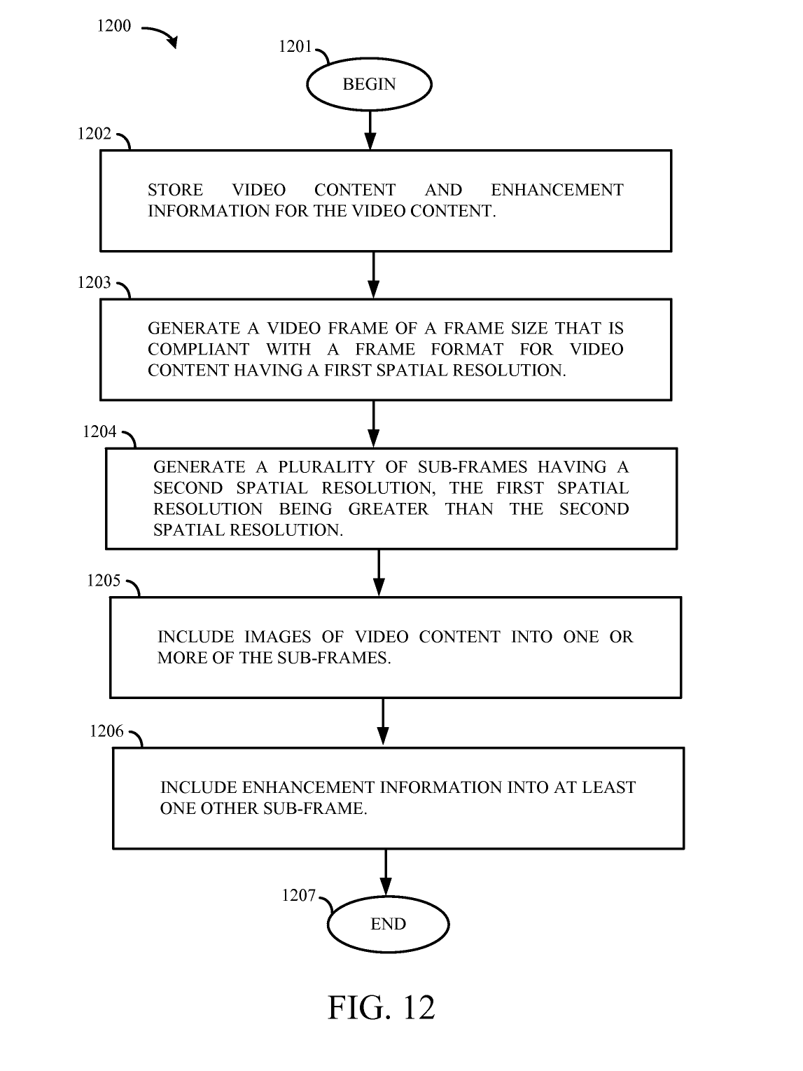

FIG. 12 is a flow chart 1200 of a method for packing video frames using the frame packing and encoding system 110. At step 1201, the method for packing video frames begins. At step 1202, the memory unit 201 stores video content received from the video camera 202 or from the communication transmitter 206. At step 1202, the memory unit also stores enhancement information received from the communication transmitter 206 or from the processor 203.

At step 1203, the frame packer 306 generates a video frame of a frame size that is compliant with a frame format for video content having a first spatial resolution. For example, the frame packer 306 may generate a UHDTV frame having 4K spatial resolution.

At step 1204, the frame packer 306 generates a plurality of sub-frames having a second spatial resolution, the first spatial resolution being greater than the second spatial resolution. For example, when the frame packer 306 generates a 4K UHDTV video frame, the frame packer 306 may generate 1080P spatial resolution sub-frames.

At step 1205, the frame packer 306 includes images of video content into one or more of the sub-frames. For example, the images in the one or more sub-frame may comprise images of the baseline video content.

At step 1206, the frame packer 306 includes enhancement information into at least one of the other sub-frames. For example, the enhancement information may comprise color enhancement information. At step 1207, the method for packing video frames ends.

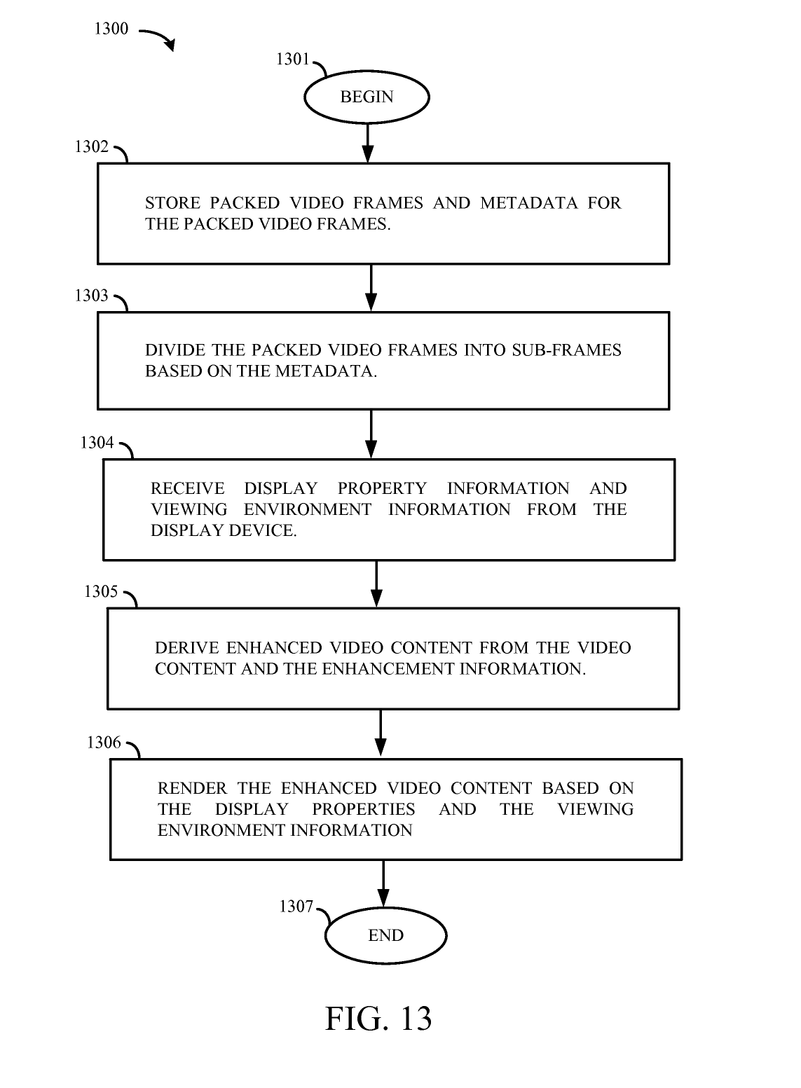

FIG. 13 is a flow chart 1300 of a method for rendering enhanced video content using the decoding and rendering system 130. At step 1301, the method for rendering enhanced video content begins. At step 1302, the memory unit 403 stores packed video frames and metadata for the packed video frames. The memory unit 403 may receive the packed video frames and the metadata from the video decoder 404.

At step 1303, the video renderer 405 divides the packed video frames into sub-frames based on the metadata. Each of the sub-frames may comprise an image of video content or enhancement information.

At step 1304, the video renderer 405 receives display property information and viewing property information from the display device 140.

At step 1305, the video renderer 405 derives the enhanced video content from the video content and the enhancement information.

At step 1306, the video renderer 405 renders the enhanced video content based on the display properties and the viewing environment information. At step 1307 the method for rendering enhanced video content ends.

The information and signals disclosed herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality in varying ways for each particular application, but such implementation decisions should not be interpreted as causing a departure from the scope of the disclosure.

The techniques described herein may be implemented in hardware, software, firmware, or any combination thereof. Such techniques may be implemented in any of a variety of devices such as general purposes computers or integrated circuit devices having multiple uses. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Various embodiments have been described. These and other embodiments are within the scope of the following claims.

What is claimed is:

1. An apparatus for processing image or video information, comprising:
a memory circuit configured to store video content and enhancement information for the video content; and
a processor coupled to the memory circuit and configured to generate a video frame of a frame size that is compliant with a frame format for video content having a first spatial resolution, the video frame comprising at least a first sub-frame and a second sub-frame, wherein the first sub-frame comprises an image of video content having a second spatial resolution, the first spatial resolution being greater than the second spatial resolution, and the second sub-frame comprises enhancement information for the video content of the first sub-frame.

2. The apparatus of claim 1, wherein the image of video content of the first sub-frame has a first dynamic range and a first color gamut and the enhancement information indicates an enhanced video frame based on the image of video content of the first sub-frame, the enhanced video frame having a second dynamic range and a second color gamut, the second dynamic range higher than the first dynamic range and/or the second color gamut wider than the first color gamut.

3. The apparatus of claim 2, wherein the processor is further configured to determine a luminance ratio and a chrominance difference between the image of video content of the first sub-frame and the enhanced video frame, and wherein the enhancement information comprises the luminance ratio and the chrominance difference.

4. The apparatus of claim 3, wherein the processor is further configured to transform a bit-depth and/or a color space of the luminance ratio and the chrominance difference to a bit-depth and a color space of the video frame format for video content.

5. The apparatus of claim 1, wherein the enhancement information comprises information for increasing at least one of a dynamic range of the video content, a color gamut of the video content, a frame rate of the video content, or a number of dimensional views of the video content.

6. The apparatus of claim 1, wherein the enhancement information of the second sub-frame comprises a second image of video content, the image of video content of the first sub-frame and the second image of video content providing video content at a frame rate that is higher than a frame rate of the frame format for video content.

7. The apparatus of claim 1, wherein the image of video content of the first sub-frame has a first view and the enhancement information comprises a second image of video content has a second view, the first view and the second view providing a frame of stereoscopic video content.

8. The apparatus of claim 1, the processor is further configured to scale a spatial resolution of video content down to a spatial resolution that is not greater than the second spatial resolution.

9. The apparatus of claim 1, where the processor is further configured to generate a metadata signal indicating encoding parameters for encoding the first sub-frame and the second sub-frame.

10. The apparatus of claim 1, further comprising an encoder configured to independently encode the first sub-frame according to a first set of encoding parameters, and the second-sub frame according to a second set of encoding parameters.

11. The apparatus of claim 1, wherein the enhancement information comprises a depth-based saliency image indicating a processing complexity for rendering regions of the image of video content of the first sub-frame.

12. The apparatus of claim 1, wherein the enhancement information comprises a depth-based object segmentation map indicating display processing algorithms for objects in the image of video content of the first sub-frame and providing motion tracking of the objects.

13. The apparatus of claim 1, wherein the enhancement information comprises a rendering metadata map indicating rendering functions for rendering a video frame based on the first sub-frame, the second sub-frame, and dynamic range and color gamut capabilities of a display.

14. The apparatus of claim 13, wherein the metadata maps indicate a rendering function based on a table of functions.

15. The apparatus of claim 1, wherein the video frame comprises a third sub-frame comprising second enhancement information for the video content of the first sub-frame, the second enhancement information indicating a second enhanced video frame based on the image of video content of the first sub-frame, the second enhanced video frame having a third dynamic range and a third color gamut, the third dynamic range higher than the first dynamic range and/or the third color gamut wider than the first color gamut.

16. The apparatus of claim 1, wherein the image of video content of the first sub-frame has a first dynamic range and a first color gamut and the enhancement information indicates a diminished video frame based on the image of video content of the first sub-frame, the diminished video frame having a second dynamic range and a second color gamut, the second dynamic range lower than the first dynamic range and/or the second color gamut narrower than the first color gamut.

17. The apparatus of claim 1, wherein the frame is compliant with the ultra-high definition television UHDTV1 frame format, and wherein the first spatial resolution is 3840 by 2160 and the second spatial resolution is 1920 by 1080.

18. A method for processing image or video information, comprising:
storing video content and enhancement information for the video content; and
generating a video frame of a frame size that is compliant with a frame format for video content having a first spatial resolution, the video frame comprising at least a first sub-frame and a second sub-frame, wherein the first sub-frame comprises an image of video content having a second spatial resolution, the first spatial resolution being greater than the second spatial resolution, and the second sub-frame comprises enhancement information for the video content of the first sub-frame.

19. The method of claim 18, wherein the image of video content of the first sub-frame has a first dynamic range and a first color gamut and the enhancement information indicates an enhanced video frame based on the image of video content of the first sub-frame, the enhanced video frame having a second dynamic range and a second color gamut, the second dynamic range higher than the first dynamic range and/or the second color gamut wider than the first color gamut.

20. The method of claim 19, further comprising determining a luminance ratio and a chrominance difference between the image of video content of the first sub-frame and the enhanced video frame, and wherein the enhancement information comprises the luminance ratio and the chrominance difference.

21. The method of claim 18, wherein the enhancement information of the second sub-frame comprises a second image of video content, the image of video content of the first sub-frame and the second image of video content providing video content at a frame rate that is higher than a frame rate of the frame format for video content.

22. The method of claim 18, further comprising independently encoding the first sub-frame according to a first set of encoding parameters and the second-sub frame according to a second set of encoding parameters.

23. An apparatus for processing image or video information, comprising:
means for storing store video content and enhancement information for the video content; and
means for generating a video frame of a frame size that is compliant with a frame format for video content having a first spatial resolution, the video frame comprising at least a first sub-frame and a second sub-frame, wherein the first sub-frame comprises an image of video content having a second spatial resolution, the first spatial resolution being greater than the second spatial resolution, and the second sub-frame comprises enhancement information for the video content of the first sub-frame.

24. The apparatus of claim 23, wherein the image of video content of the first sub-frame has a first dynamic range and a first color gamut and the enhancement information indicates an enhanced video frame based on the image of video content of the first sub-frame, the enhanced video frame having a second dynamic range and a second color gamut, the second dynamic range higher than the first dynamic range and/or the second color gamut wider than the first color gamut.

25. The apparatus of claim 24, further comprising means for determining a luminance ratio and a chrominance difference between the image of video content of the first sub-frame and the enhanced video frame, and wherein the enhancement information comprises the luminance ratio and the chrominance difference.

26. The apparatus of claim 23, wherein the storing means comprises a memory circuit and the generating means comprises a processing circuit.

27. An apparatus for rendering image or video information, comprising:
a memory circuit configured to store video content and enhancement information for the video content; and
a processor coupled to the memory circuit and configured to receive a video frame of a frame size that is compliant with a frame format for video content having a first spatial resolution, the video frame comprising at least a first sub-frame and a second sub-frame, wherein the first sub-frame comprises an image of video content having a second spatial resolution, the first spatial resolution bring greater than the second spatial resolution, and the second sub-frame comprises enhancement information for the image of the first sub-frame, the processor further configured to generate an enhanced video frame based on the image of video content of the first sub-frame and the enhancement information, the enhanced video frame having the second spatial resolution.

28. The apparatus of claim 27, wherein the image of video content of the first sub-frame has a first dynamic range and a first color gamut and the enhancement information indicates an enhanced video frame based on the image of video content of the first sub-frame, the enhanced video frame having a second dynamic range and a second color gamut, the second dynamic range higher than the first dynamic range and/or the second color gamut wider than the first color gamut, and the processor is further configured to generate the enhanced video frame based on the image of video content of the first sub-frame and the enhancement information.

29. The apparatus of claim 27, wherein the enhancement information of the second sub-frame comprises a second image of video content and the processor is further configured to temporally arrange the image of video content of the first sub-frame and the second image of video content and generate enhanced video content at a frame rate that is higher than a frame rate of the frame format for video content based on the image of video content of the first sub-frame and the second image of video.

30. The apparatus of claim 27, wherein the enhancement information comprises a rendering metadata map indicating rendering functions and the processor is further configured to generate an enhanced video frame based on the first sub-frame, the second sub-frame, and dynamic range and color gamut capabilities of a display.
